(19) United States
(12) Patent Application Publication
(10) Pub. No.: US 2026/0052372 A1
(43) Pub. Date: Feb. 19, 2026

(54) FACILITATING PROVISIONING DOMAIN SUPPORT FOR MOBILE NETWORK ENVIRONMENTS

(71) Applicant: Cisco Technology, Inc., San Jose, CA (US)

(72) Inventors: Srinath Gundavelli, San Jose, CA (US); Vimal Srivastava, Bangalore (IN); Ravi Kiran Guntupalli, Cumming, GA (US)

(21) Appl. No.: 18/808,244

(22) Filed: Aug. 19, 2024

(51) Int. Cl. H04W 8/18; H04W 48/16

(52) U.S. Cl. CPC H04W 8/18; H04W 48/16

(57) ABSTRACT

Provided herein are techniques to facilitate providing Provisioning Domain (PVD) support in a mobile network environment. In one example, a method may include obtaining an indication of a triggering event for a wireless device involving connectivity of the wireless device with a mobile network; determining, based the indication of the triggering event, a provisioning domain (PVD) object that the wireless device is to obtain from an element of the mobile network; and providing a network resource identifier for the PVD object to the wireless device that enables the wireless to device to obtain the PVD object from the element of the mobile network. In at least one instance, the network resource identifier is a Uniform Resource Identifier (URI) that enables to the wireless device to query the element of the mobile network and obtain the particular PVD object.

### TECHNICAL FIELD

The present disclosure relates to network equipment and services.

### BACKGROUND

Networking architectures have grown increasingly complex in communications environments, particularly mobile networking environments. Mobile communication networks have grown substantially as end users become increasingly connected to mobile network environments. With the growth of new mobile communication networks, new opportunities are presented for providing wireless connectivity for wireless devices with regard to connectivity policies that may be enabled for such devices.

### BRIEF DESCRIPTION OF THE DRAWINGS

FIG. 1 illustrates a system that may be provided to facilitate providing Provisioning Domain (PVD) support for a mobile network, according to an example embodiment.

FIGS. 2A, 2B, 2C, and 2D illustrate example PVD objects that can be configured for and provided to a wireless device via a mobile network, according to various example embodiments.

FIGS. 3A, 3B, 3C, and 3D are a message sequence diagram illustrating example operations that can be performed to facilitate providing PVD objects to a wireless device in a mobile network environment, according to an example embodiment.

FIG. 4 is a flow chart depicting a method according to an example embodiment.

FIG. 5 illustrates a hardware block diagram of a computing device configured to perform functions associated with operations discussed in connection with embodiments herein.

### DETAILED DESCRIPTION

### Overview

Provided herein are techniques to facilitate providing Provisioning Domain (PVD) support in a mobile network environment. Embodiments herein provide an approach for extending PVD semantics to cellular/wireless wide area mobile network access such that one or more PVD data structures or objects including one or more PVD configurations can be sent to a wireless device connected to a mobile network. The PVD structure of PVD objects as provided via embodiments herein may provide for the ability to organize PVD configuration in a structured manner, which may allow a mobile network to compartmentalize configurations as PVD domains. PVD objects can be defined at any level as provided by embodiments herein (e.g., at a slice level, at a subscriber level, at a Data Network Name (DNN) level, at a cell level, etc. At least one advantage of embodiments herein is the realization of an access agnostic configuration interface between a wireless device and mobile network.

In at least one embodiment, a computer-implemented method is provided that may include obtaining an indication of a triggering event for a wireless device involving connectivity of the wireless device with a mobile network; determining, based the indication of the triggering event, a provisioning domain (PVD) object that the wireless device is to obtain from an element of the mobile network; and providing a network resource identifier for the PVD object to the wireless device that enables the wireless to device to obtain the PVD object from the element of the mobile network. In at least one embodiment, the network resource identifier is a Uniform Resource Identifier (URI) that enables to the wireless device to query the element of the mobile network and obtain the PVD object.

### Example Embodiments

A Provisioning Domain (PVD or PvD) is defined in Internet Engineering Task Force (IETF) Request For Comments (RFC) 7556 as a consistent set of network configuration information. Generally, PVDs offer an approach for organizing configuration data and delivering such information (for a provisioning domain) from a network to a device. PVD configuration information can include properties, also referred to as PVD elements or PVD configuration elements, which are traditionally associated with a single networking interface, such as source addresses, Domain Name System (DNS) configuration, gateway addresses, and various policies such as Application-QoS (Quality of Service) definitions.

For instance, a user with a device connected to an access network and concurrently running a Virtual Private Network (VPN) session to their corporate network can receive two distinct sets of configurations. Each of these sets can be designated as a provisioning domain and then logically linked to an interface. As a result, the device can be made aware of each provisioning domain, enabling the device to use the associated configuration solely within a specific context. Such PVD configuration elements can be delivered in-band by including them in Network Discovery (ND) messages.

There is strong interest for PVD support from device eco-system vendors that can include PVD support in the operating system (OS) stacks of different devices. PVD has the potential to become a de facto configuration approach for organizing configuration data and making it available to the endpoint, independent of the access technology.

Third Generation Partnership Project (3GPP) standards utilize Protocol Configuration Options (PCO) for delivering configuration options to wireless devices such that a PCO can sent in a Session Management (SM) message to given wireless device. However, for delivering route selection policies, a user equipment (UE) Route Selection Policy (URSP) can be sent to a wireless device to influence route selection(s) by the device for different data flows or Protocol Data Unit (PDU) sessions. However, adoption of URSP type policies, similar to the adoption of Access Network Discovery and Selection Function (ANDSF) type policies, has seen limited adoption among mobile network operators (MNOs).

Thus, it would be advantageous to facilitate PVD support for configuration and policy delivery in a mobile network environment. For instance, Authentication, Authorization, and Accounting (AAA) functions supporting Remote Authentication Dial-In User Service (RADIUS)-based interfaces can be enhanced to support Hypertext Transfer Protocol (HTTP)-based interfaces for supporting PVD URIs.

Further, 3GPP networks elements, such as a Unified Data Management (UDM) entity, a Policy Control Function (PCF), and/or the like can also be enhanced, in accordance with embodiments herein, in order to support providing PVD URIs to wireless devices to enable devices to obtain different PVD objects based on various mobile network triggers associated with wireless devices having mobile network connectivity.

In accordance with embodiments herein, techniques are provided for extending PVD semantics to 3GPP wireless wide area/cellular accesses for mobile network environments. In accordance with embodiments herein, use of one or more PVD objects may allow a mobile network to facilitate the delivery PVD configurations to a wireless device.

The PVD structure of PVD objects discussed for embodiments herein may provide for organizing the PVD configurations (PVD elements/configuration elements) in a structured manner, which may allow a mobile network (e.g., one or more nodes/elements of the mobile network) to compartmentalize configurations as PVD domains. PVDs can be defined at different levels or domains, such as at a slice level, DNN level, cell level and/or the like in accordance with embodiments herein. At least one advantage of embodiments herein is the realization of an access agnostic configuration interface between a wireless device and mobile network.

In at least one embodiment, a mobile network node can determine a triggering event for a wireless device and can determine, based on the triggering event/parameters associated with the triggering event, a PVD object that is to be obtained by the wireless device. A network resource identifier indicating a network resource from where the wireless device can obtain a particular PVD object can be provided to the wireless device or can be generated by the wireless device. In at least one embodiment, a network resource identifier provided to a wireless device or generated by the wireless device may be formatted as a Uniform Resource Identifier (URI), also referred to herein as a PVD URI, which can be accessed by the wireless device in order to obtain a particular PVD object. In at least one embodiment, a PVD URI for a particular PVD object can be configured in a manner that provides a unique, but predictable URI format based on the provisioning domain for the particular PVD object.

In some embodiments, a PVD object for a particular provisioning domain containing any number of PVD elements/configuration elements may be delivered to a wireless device via a URSP.

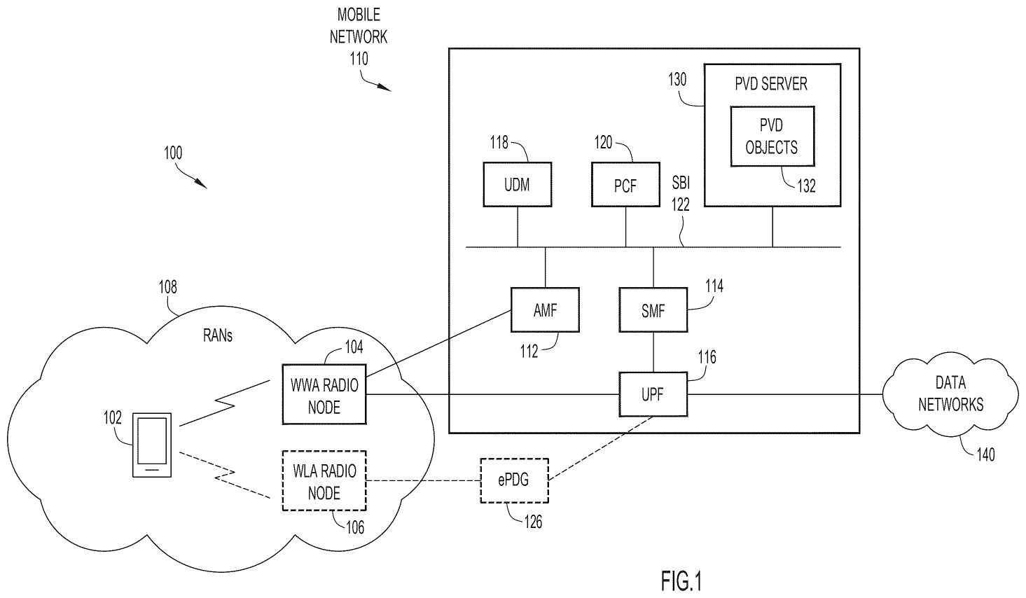

Referring to FIG. 1, FIG. 1 illustrates a system 100 that may be provided to facilitate providing Provisioning Domain (PVD) support for a mobile network, according to an example embodiment. In at least one embodiment, system 100 may include a wireless device 102 and a wireless wide area (WWA) radio node 104 for a Radio Access Network (RAN) 108.

Also shown in FIG. 1 is a mobile network 110, that may include a number of network functions (NFs), such as an Access and Mobility Management Function (AMF) 112, a Session Management Function (SMF) 114, a User Plane Function (UPF) 116, a Unified Data Management (UDM) entity, referred to herein as UDM 118, a Policy Control Function (PCF) 120, and a PVD server 130. Also shown in FIG. 1 are one or more data networks 140.

Also shown in FIG. 1 are one or more data networks 140, such as the public Internet, an enterprise/private network (e.g., a business entity, a government entity, an education entity, etc. to serve enterprise purposes), an Internet Protocol (IP) Multimedia Subsystem (IMS), an Ethernet network/switching system, and/or the like. The Internet, an IMS, etc. may be associated with a data network name (DNN) (or an Access Point Name (APN) for a 4G/LTE connection), which can be identified for one or more protocol data unit (PDU) sessions that can be established via mobile network 110 for a user equipment (UE) or wireless device, such as a wireless device 102 as shown in FIG. 1.

Generally, for system 100, WWA radio node 104 may interface with AMF 112 and UPF 116. The AMF 112 may further interface with SMF 114, which may also interface with UPF 116, which may also interface with data networks 140. A Service-Based Interface (SBI) 122 may facilitate interfacing between the UDM 118, PCF 120, AMF 112, SMF 114, and PVD server 130, each of which may also interface with UPF 116 in accordance with embodiments herein. UDM 118 can interface with and/or be implemented in combination with a Unified Data Repository (UDR) (not shown in FIG. 1).

In at least one embodiment WWA radio node 104 may be implemented as any combination of a Third Generation Partnership Project (3GPP) Fifth Generation (5G) New Radio (NR) radio node, such as a gNodeB (gNB); a 3GPP Fourth Generation (4G)/Long Term Evolution (LTE) radio node, such as an evolved Node B (eNodeB or eNB), and/or any next Generation (nG) radio node capable of facilitating cellular/wireless wide area network (WWAN) Radio Frequency (RF) communications with wireless device 102.

In at least one embodiment, a wireless local area (WLA) radio node 106 may also be provided for the RAN 108 to facilitate a trusted wireless local area network (WLAN) access (e.g., trusted Wi-Fi access) in which the WLA radio node 106 may interface with an evolved Packet Data Gateway (ePDG) 126 that may further interface with UPF 116. In at least one embodiment, WLA radio node 106 may be a WLAN access point (AP) (or Wi-Fi AP) capable of facilitating any combination of Institute of Electrical and Electronics Engineers (IEEE) 802.11 (any variation thereof) Wi-Fi/WLAN RF communications with wireless device 102.

Mobile network 110 may be implemented as any combination of a 4G/LTE core network, a 5G core (5GC) network, an nG core network (e.g., sixth generation (6G) or beyond), and/or the like. Mobile network 110 may include any number of physical network functions (PNFs) and/or virtualized network functions (VNFs), broadly referred to herein as NFs, such as AMF 112, SMF 114, UPF 116, UDM 118, and PCF 120 as shown in FIG. 1; however, it is to be understood that mobile network 110 may include any other NFs in accordance with any applicable wireless wide area and/or wireless local area standards.

In some embodiments, one or more network slices may be provided via mobile network 110. A network slice is a logical end-to-end network, often instantiated via a combination of slice resources, such as VNFs, in which the network slice can be dynamically created (instantiated) and may include any combination of 3GPP mobile network functions/functionality (e.g., any combination of user plane and/or control plane functions). Thus, a network slice can generally refer to a group or set of slice resources that are configured and instantiated in order to facilitate mobile network services. In accordance with 3GPP standards, a network slice may be identified via a Single Network Slice Selection Assistance Information (S-NSSAI) identifier; however, for various examples/operations discussed for embodiments herein, network slices may be identified using numerical labels, for ease of illustration/discussion only.

PVD server 130 can be implemented by an MNO (e.g., 5G network operator) that operates mobile network 110. In at least one embodiment, the PVD server 130 can include/be configured with a number of PVD objects, also referred to herein as PVD data structures, data objects, PVD configuration objects, and variations thereof, shown in FIG. 1 as PVD objects 132. In accordance with embodiments herein, various PVD configuration elements can be configured or organized under a PVD object or data structure via JavaScript Object Notation (JSON) elements.

In at least one embodiment, a particular PVD object can be made accessible/accessed via a network resource identifier provided to a wireless device, such as via a particular Uniform Resource Identifier (URI) configured for the particular PVD (also referred to herein interchangeably as a PVD URI) that can be queried or accessed by a wireless device, such as wireless device 102, in order to obtain the particular PVD object and any configuration elements contained therein.

PVD URIs configured in accordance with embodiments herein may be queried via any protocol interfaces, such as HTTP, Dynamic Host Configuration Protocol (DHCP) and/or any other protocol interface.

Although PVD objects are discussed for various examples herein with respect to being configured/stored via PVD server 130, in some embodiments, PVD objects may also be configured/stored via PCF 120. Further, although PVD server 130 is shown in FIG. 1 as implemented separate from PCF 120, in some embodiments PVD server 130 may be implemented within or as part of PCF 120. For example, in some implementations an MNO may desire to implement PVD functionality for a mobile network deployment but may not want to provide such functionality via a separate server/device. In such instances, the MNO may implement PVD logic (to perform operations as discussed herein for a PVD server) via a PCF rather than implementing a separate PVD server network element. In some instances, implementing PVD logic via a PCF rather than via a standalone network element may case or enable integration into a mobile network environment, as PVD signaling within the mobile network environment may, in various scenarios, be piggybacked on PCF interfaces/signaling for a deployment and/or be provided as extensions of PCF signaling.

In at least one embodiment, PVD configurations/PVD objects may be managed for PVD server 130 via one or more elements of mobile network 110 at one or more different service levels in which the PVD objects/configurations can be tied or otherwise associated to a predictable URI format in which a service identifier/service level of a given PCD object can be included as a key/differentiating element in a given PVD URI. In some embodiments, PVD objects/URIs can be stored via the PCF 120, such as, for example, via a UE-PCF element, and/or via any other policy databases.

In at least one embodiment, a wireless device, such as wireless device 102 can be configured with PVD logic that enables the wireless device to use service identifiers from a current and/or previous PDU session in order to construct a particular PVD URI that enables the wireless device to query a network element (e.g., PVD server 130, PCF 120, etc.) in order to obtain a particular PVD object associated/configured for the particular PVD URI (e.g., via an HTTP query, a DHCP query, etc. to obtain a particular PVD configuration set). In at least one embodiment, a wireless device, such as wireless device 102, can discover an operator owned Private networks (PNI-NPN's) by formulating a PVD query encoding elements representative of the wireless device's current location.

Although PVD queries are discussed for various examples herein, in at least one embodiment, the mobile network 110, such as via AMF 112, SMF 114, and/or UPF 116 may push a list of service URIs to the wireless device 102 that are relevant to the context of the wireless device 102 (e.g., session, slice, DNN, etc. context for the wireless device). In at least one embodiment, the PCF 120 (e.g., a UE-PCF element of the PCF 120) can include a list of PVD URIs (for various service identifiers relevant to a given wireless device (e.g., PDU session, slice, DNN, application, etc.) in a URSP configuration that can be deliver it to a given wireless device. In at least one embodiment for system 100, one or more PVD object(s) obtained by wireless device 102 may be provided precedence over a PCO and/or URSP stored by the wireless device 102.

In various embodiments, the PVD server 130 (or any other network element/resource at which PVD objects are stored/maintained) can include any combination of static PVD object(s) and/or dynamic PVD objects (e.g., broadly, PVD objects 132, as shown in FIG. 1).

Generally, a static PVD object may be considered a set of configurations/configuration elements that may not change and can be related to various network and/or subscriber attributes in which the information may be valid for the whole of a Home Public Land Mobile Network (H-PLMN) of a subscriber/wireless device. Generally, a dynamic PVD object may be considered a set of configurations/configuration elements that can change under various circumstances/based on different triggers, such as depending on wireless device/UE/subscription information, a cell and/or Tracking Area Identifier (TAI) for the WWA radio node to which a wireless device/UE is connected and/or is handed over to, allowed and/or accessed slice(s), combinations thereof, and/or the like.

In various embodiments, PVD objects can be statically configured or can be dynamically generated based on various triggering events and/or parameters included in one or more PVD updates and/or PVD configuration updates received, for example, by PVD server 130. Such PVD updates and/or PVD configuration updates may generally be referred to as an indication of a triggering event being determined/identified for a given wireless device, such as wireless device 102.

Any information/elements may be provided for a PVD object in accordance with embodiments herein, such as a Proxy Call Session Control Function (P-CSCF) that can be utilized for Session Initiation Protocol (SIP) sessions involving an IMS, a DNS Internet Protocol (IP) address (e.g., IP version 4 (IPv4) and/or IP version 6 (IPv6) address), a Local Area Data Network (LADN) configuration for different Tracking Area Identifiers (TAIs) and/or Routing Area (RAs), application clients (ACs) and/or Edge Application Servers (EAS) for different TAIs/RAs, geographic location information (e.g., geo-location, geographic area, geographic region, etc.) and/or the like.

In one example, a PVD object JSON configuration may be formatted, as follows:

```
{
  “pvd”: {
    “event”: “PDU Connection”,
    “pvd-id”: “pvd://mnc410.mcc310.3gppnetwork.org/DNN/ims”,
    “description”: “IMS Configuration Objects”,
    “P-CSCF-V4”: “10.10.10.10”
    “P-CSCF-V6”: “2001 : db8: : 1234 : 5678 : 5 . 6 . 7”
    “DNS-Server: “20.20.20.20”
    “Time Zone”: “Delhi”
      “Ladn-Info”: {
        “DNN”: “abc.manhattan.com”
        “TAI-List”: “123”
        }
    }
  }
```

The example PVD object shown above may be configured for an IMS provisioning domain involving a given Public Land Mobile Network (PLMN). The example PVD object shown above identifies a particular triggering event, such as establishment of a PDU session (e.g., “event”: “PDU Connection” for an IMS session, for example), that can trigger facilitating the wireless device 102 to obtain the particular PVD object; however, in some embodiments, one or more parameters associated with a triggering event can be correlated or mapped to a PVD configuration element of a particular PVD object, which an element of the mobile network can use/identify in order to communicate a particular PVD URI (network resource identifier) to the wireless device 102 to cause the wireless device 102 to obtain the particular PVD object from the network element at which the particular PVD object is stored (e.g., PVD server 130, PCF 120 or a PVD server implemented as part of a PCF).

In various embodiments, an MNO can group PVD objects at different domains or service levels, such as at a slice level (e.g., S-NSSAI), a routing identifier level, at a cell identifier level (e.g., Evolved Cell Global Identifier (ECGI) for 4G/LTE, New Radio Cell Global Identifier (NCGI), etc.), a UE identifier (ID) level (e.g., per International Mobile Subscriber Identity (IMSI), per Subscription Permanent Identifier (SUPI), per Subscription Concealed Identifier (SUCI), etc.), an SMF identifier level, a DNN level (e.g., internet DNN, IMS DNN, etc.), a UPF identifier level, a Public Land Mobile Network (PLMN) identifier (PLMN-ID) level, on geo-location service level, service area, or basis (e.g., latitude, longitude, area, range defining an area, etc.), combinations thereof, and/or the like.

In at least one embodiment, multiple PVD objects can be grouped together based on context such that objects relevant in a given context can be grouped. In at one embodiment, PVD objects may be defined or configured with a hierarchy, a ranked order, or the like such that a same PVD configuration element may be present in multiple different PVDs. In such an embodiment, a configuration element present in a given PVD object that is higher in a given hierarchy/ranked order will be provided/given more relevance. For example, PVD-PLMN<PVD-SLICE<PVD-DNN.

As noted above, a PVD object can be configured with a unique, but predictable, network resource identifier, such as a PVD URI. In one example, a particular PVD object associated with a provisioning domain involving a particular slice, S-NSSAI(1-001), can be configured with a “pvd-id” configuration element (e.g., a PVD identifier for the particular PVD object) that includes PVD a URI that may be formatted as “PVD://mnc410.mcc310.3gppnetwork.org/S-NSSAI1-001” in which the PVD URI can be used/queried by wireless device 102 in order to retrieve the particular PVD object. In this example, the particular PVD object can be configured for a particular PLMN identified by a Mobile Network Code (MNC) of 410 (mnc410) and a Mobile Country Code (MCC) of 310 (mcc310), sometimes formatted as (410-310).

In another example, a PVD object associated with a provisioning domain involving particular SMF identifier (SMF-ID), such as SMF 114 can be configured with a “pvd-id” configuration element that includes a PVD URI that may be formatted as “PVD://mnc410.mcc310.3gppnetwork.org/SMF-ID/smf114” that can be used/queried by wireless device 102 in order to retrieve the particular PVD object (associated with PLMN (mnc410.mcc310 or 410-310), in this example).

Further, the format of a PVD object itself, such as a JSON format of PVD objects can be configured to have a unique format with regard to specific PVD configuration elements contained the PVD object (e.g., specific to the provisioning domain of a given PVD object) while having a predictable overall format (e.g., including a PVD URI, including a service identifier, including information/parameters specific to a given provisioning domain), such that a NF, such as PVD server 130 and/or any other NF of mobile network 110 can dynamically generate a PVD object for a given provisioning domain based on one or more parameters/information pertaining to the domain; for example, as determined by the NF generating the PVD object.

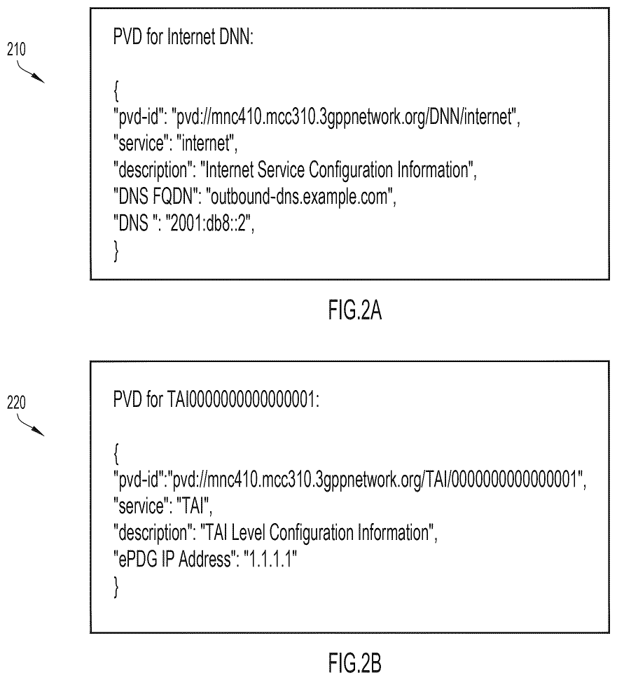

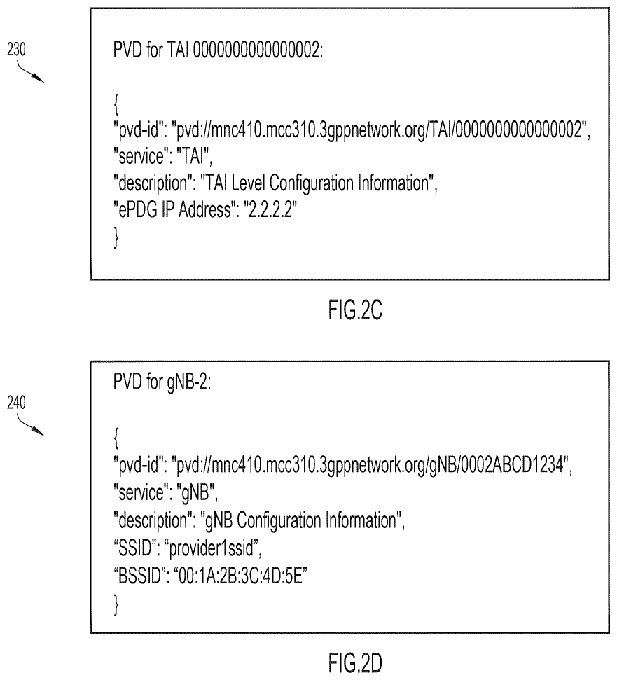

Consider other various example PVD objects as illustrated in FIGS. 2A, 2B, 2C, and 2D that can be configured/stored via one or more network elements/NFs of system 100, such as via PVD server 130 (or any other PDU server discussed herein) and provided to wireless device 102 during operation of system 100.

In one example as shown in FIG. 2A, a PVD object 210 can be configured for an Internet DNN provisioning domain and can be stored via PVD server 130. As shown in FIG. 2A, the PVD object 210 can be configured with “pvd-id” configuration element that includes a PVD URI that can be formatted as “pvd-id”: “pvd://mnc410.mcc310.3gppnetwork.org/DNN/internet” and can include a “service” configuration element that identifies an “internet” service for the PVD object 210. In one embodiment, a PVD URI associated with a given DNN provisioning domain may be formatted in a unique, but predictable format, such as “DNN/DNN-name” for any DNN with which a given wireless device may seek PDU session establishment for the PLMN (410-310).

Further, as shown for the PVD object 210, a “description” configuration element identifies various configuration objects or information for the PVD object 210, such as a Fully Qualified Domain Name (FQDN) of the DNS server (e.g., “outbound-dns.example.com”) to be used for the Internet service and an IPv6 address for the DNS server (e.g., “2001:db8::2”). It is to be understood that any configuration information can be configured for a given PVD object.

In at least one embodiment, PVD object 210 can be stored in PVD server 130 in association with or otherwise mapped to the domain to which the object pertains, for example, stored in association with the MCC-MNC and DNN to which the PVD object pertains (e.g., [PVD object 210]<==>410-310 (DNN: Internet)) that can be used to identify the PVD object 210 and provide the corresponding PVD URI to a wireless device that is to obtain the PVD object 210.

In another example, as shown in FIG. 2B, a PVD object 220 can be configured for a TAI provisioning domain involving a tracking area, ‘TAI-1’ (e.g., TAI 0000000000000001) and can be stored via PVD server 130. As shown in FIG. 2B, the PVD object 220 can be configured with “pvd-id” configuration element that includes a PVD URI that can be formatted as “pvd-id”: “pvd://mnc410.mcc310.3gppnetwork.org/TAI/0000000000000001” and can include a “service” configuration element that identifies a “TAI” service for the PVD object 220. With reference to the “service” configuration element, consider that there are different PVD configurations that can be configured at different service levels, such as at a TAI level as shown in FIG. 2B, at a DNN level as shown in FIG. 2A, at a gNB level as shown in FIG. 2D, etc. As illustrated for FIG. 2B, there are some configurations which can be configured at a TAI level. Meaning, a wireless device/UE when attached to given TAI can fetch/receive/obtain an associated configuration set relevant for the given TAI, for example, via a PVD object configured for the given TAI. When the UE moves to a different TAI, the configuration can be modified, for example, with a different PVD object configured for the different TAI or via updates to the PVD object for the (first) given TAI.

In one embodiment, a PVD URI for a TAI provisioning domain may be formatted in a unique, but predictable format, such as “TAI/TAI-value” for any TAI within which a given wireless device may establish a radio connection with a given radio node (e.g., WWA radio node 104) within the PLMN (410-310).

Further, as shown for the PVD object 220, a “description” configuration element identifies various configuration objects or information for the PVD object 220, such as an ePDG IP address (e.g., for ePDG 126) to be used by the wireless device 102 while within TAI-1. It is to be understood that any configuration information can be configured for a given PVD object.

Thus, in accordance with embodiments herein, as illustrated with reference to PVD object 220, by mapping configuration parameters to 5G service identifiers, such as TAI, RAI (Routing Area Identifier), etc., the mobile network 110 can activate a new behavior for wireless device 102. For example, for users in carrier aggregation (CA) region when connecting to a mobile network via a non-3GPP access, such as a trusted WLA/trusted Wi-Fi, it is often preferable for the users to utilize a specific ePDG for connection to the mobile network. However, conventional deployments often lack the ability to enable a wireless device to lookup/obtain an ePDG configuration (e.g., IP address) relevant to the context of the wireless device.

In accordance with embodiments herein, as illustrated via the PVD object 220, an ePDG configuration can be configured that can be provided to a wireless device, such as wireless device 102, based on a query of the device to obtain the PVD object. That is, for the example illustrated for FIG. 2B, the wireless device 102 can use the ePDG IP address as identified via PVD object 220, that the wireless device 102 can use for its non-3GPP (e.g., trusted WLAN/Wi-Fi) access. From the last attached TAI, the wireless device 102 can obtain the configuration set that includes the ePDG IP address.

In at least one embodiment, PVD object 220 can be stored in PVD server 130 in association with or otherwise mapped to the domain to which the object pertains, for example, stored in association with the MCC-MNC and TAI to which the PVD object pertains (e.g., [PVD object 220]<==>410-310 (TAI: 0000000000000001)) in which such information can be used by the PVD server 130 to identify the PVD object 220 and provide the corresponding PVD URI to a wireless device that is to obtain the PVD object 220.

Other configuration elements that can be provided for different service levels may include environments, such as operator hosted private networks in which an operator can offload some devices/traffic to local private networks. In such scenarios, PVD configuration elements can include network identifying information, such as a PLMN ID and or a network ID (NID) indicating a Private Network Integrated-Non-Public Network (PNI-NPN) or Standalone Non-public Network (SNPN), such that a wireless device in a given TAI can discover such networks via a given PVD object configured for the given TAI and provided/received/obtained by the wireless device. Thus, embodiments herein may enable location-based services for wireless devices.

For example, in some embodiments, PVD objects can also be defined on a geo-location basis, meaning that a set of configuration elements/parameters can be defined under a given PVD object that can be associated with a given geo-spatial region. In such instances, a wireless device, based on its geo-location/geographic area, can be provided the PVD object and corresponding configuration(s) that are associated with the geographic area. In such instances, a PVD URI for such a PVD object may be formatted as “pvd://geolocation/longitude/24.22/latitude/12.22” (e.g., for a longitude of 24.22 and a latitude of 12.22). In some implementations, a URI can be encoded with additional parameters to represent an area, such as by specifying a radius as an augmented parameter to the URI, which may include, for example, a minimum latitude (min-lat), a maximum latitude (max-lat), a minimum longitude (min-long), and a maximum longitude (max-long) that may define the radius, a polygon format that may define the radius as prescribed in IETF RFC 5870, combinations thereof, and/or the like that may define a service area/region for a given PVD object.

In another example as shown in FIG. 2C, a PVD object 230 can be configured for another TAI provisioning domain involving another tracking area, ‘TAI-2’ (e.g., TAI 0000000000000002) and can be stored via PVD server 130. As shown in FIG. 2C, the PVD object 230 can be configured with “pvd-id” configuration element that includes a PVD URI that can be formatted as “pvd-id”: “pvd://mnc410.mcc310.3gppnetwork.org/TAI/0000000000000002” and can include a “service” configuration element that identifies a “TAI” service for the PVD object 230. Further, as shown for the PVD object 230, a “description” configuration element identifies various configuration objects or information for the PVD object 230, such as an ePDG IP address for another cPDG (another cPDG different from ePDG 126 and not shown in FIG. 1) that is different than the IP address of the ePDG for TAI-1 that is to be used by the wireless device 102 while within TAI-2.

In another example, as shown in FIG. 2D, a PVD object 240 can be configured for a gNB provisioning domain involving a gNB-2 (e.g., gNB(<GNBID>) or gNB(<PLMNID>.<GNBID>), in which the <GNBID> is an NR cell identity typically represented as a 64 or 128-bit number, such as 0x0002ABCD1234 or 0x1234567890ABCDEF0002ABCD1234) and can be stored via PVD server 130. As shown in FIG. 2D, the PVD object 240 can be configured with “pvd-id” configuration element that includes a PVD URI that can be formatted as “pvd-id”:

“pvd://mnc410.mcc310.3gppnetwork.org/gNB/0002ABCD1234” and can include a “service” configuration element that identifies a “gNB” service for the PVD object 240. In one embodiment, a PVD URI for a gNB (or any other radio node-level) provisioning domain may be formatted in a unique, but predictable format, such as “RadioNodeType/Node-ID” for any radio node to which a given wireless device may establish a radio connection within a given PLMN or other network identifier (e.g., Service Set Identifier (SSID) or the like for a wireless local area network (WLAN)/Wi-Fi network).

Further, as shown for the PVD object 240, a “description” configuration element identifies various configuration objects or information for the PVD object 240, such as an operator non-3GPP network (WLAN/Wi-Fi) network that a wireless device is to utilize when connected to a given gNB. For example, in one instance, PVD object may include configuration elements identifying a service set identifier (SSID) (e.g., ‘providerlssid’) and basic service set identifier (BSSID) (e.g., ‘00:1A:2B:3C:4D:5E’). In another example, additional information for a provider network, such as a PLMN ID, etc. can be provided in the PVD object 240. In at least one embodiment, PVD object 240 can be stored in PVD server 130 in association with or otherwise mapped to the domain to which the object pertains, for example, stored in association with the MCC-MNC and gNB NCI (NR Cell ID) (in which the MCC, MNC, and NCI are combined to create an NCGI) to which the PVD object pertains (e.g., [PVD object 240]<==>410-310 (gNB: 002)) in which such information can be used by the PVD server 130 to identify the PVD object 240 and provide the corresponding PVD URI to a wireless device that is to obtain the PVD object 240.

With reference again to FIG. 1, during operation of system 100 in accordance with at least one embodiment, one or more PVD objects can be queried and obtained by any elements as shown in system 100 based on one or more triggering events. For example, PVD object(s) can be queried and obtained by wireless device 102 based on one or more triggering event(s) determined for the wireless device 102. Queries are not limited to wireless devices, however, as a PVD object may also be queried/obtained by any network functions, based on any combination of triggers, such as subscribed slice(s), allowed slice(s), rejected slice(s), URSP, Radio Access Technology (RAT)/Frequency Selection Priority (RFSP) index, ANDSF policy, and/or the like.

Broadly during operation of system 100, one or more PVD URI(s) can be sent/provided to an element of mobile network 110 and/or a wireless device connected thereto, such as wireless device 102, through one or more Router Advertisement (RA) message(s) sent by a UPF, such as UPF 116, to the wireless device 102 based on one or more triggering events determined for the wireless device.

Different triggering events, such as mobility events, session events, and/or subscription events can be determined for wireless device 102 that can trigger sending a PVD URI to the wireless device 102 to obtain a particular PVD object. The network element/NF at which PVD objects are maintained, such as PVD objects 132, can establish subscriptions with one or more NFs of mobile network 110 in order to request notifications regarding various triggering events involving wireless device 102.

For example, in at least one embodiment, PVD server 130 can establish a subscription with AMF 112 to be notified regarding any mobility events or updates involving wireless device 102 (e.g., mobile network registration, cell changes, TAI changes, roaming, etc.). In at least one embodiment, PVD server 130 can establish a subscription with SMF 114 to be notified regarding any session events or updates involving wireless device 102 (e.g., PDU session establishment, anchor UPF change, etc.). In at least one embodiment, PVD server 130 can establish a subscription with UDM 118 to be notified regarding any subscription events or updates involving wireless device (e.g., subscription updates, PVD object/configuration updates, subscription updates related to mobile network registration, etc.).

A subscription established with a NF, such as any of AMF 112, SMF 114, and/or UDM 118 from the PVD server 130 can include subscription information for identifying the wireless device, such as International Mobile Subscriber Identity (IMSI), Subscription Permanent Identifier (SUPI), Subscription Concealed Identifier (SUCI), and/or the like.

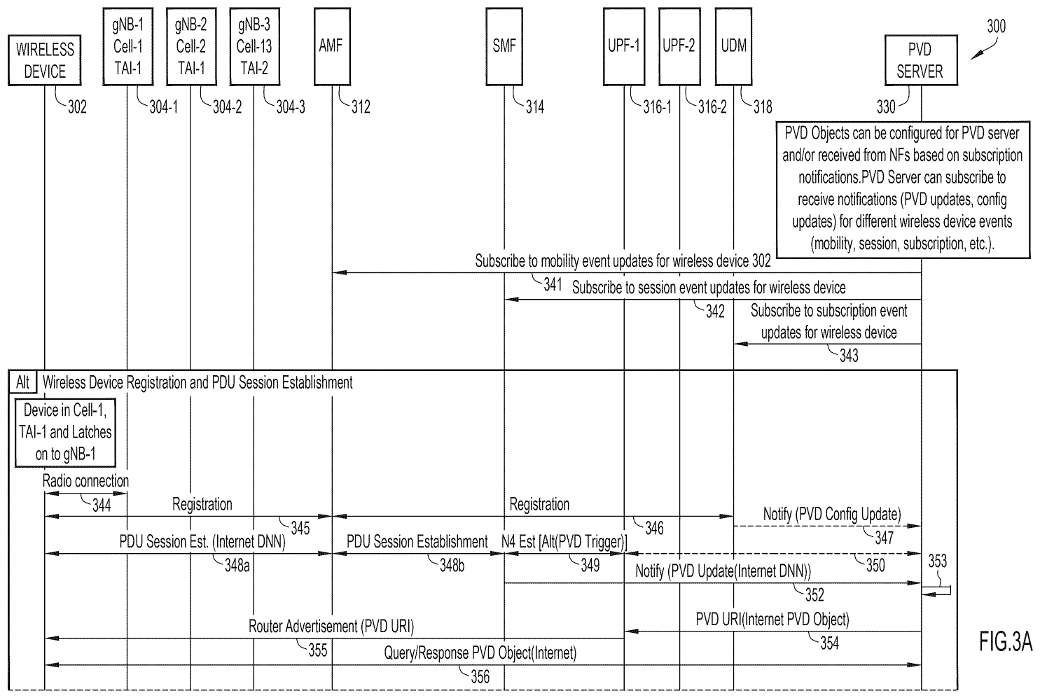

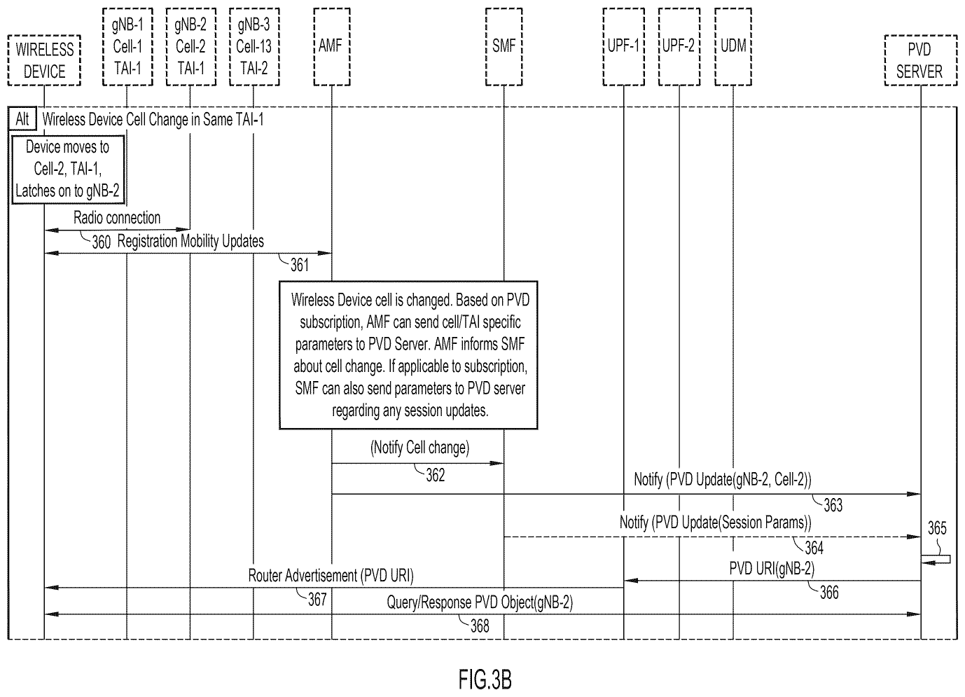

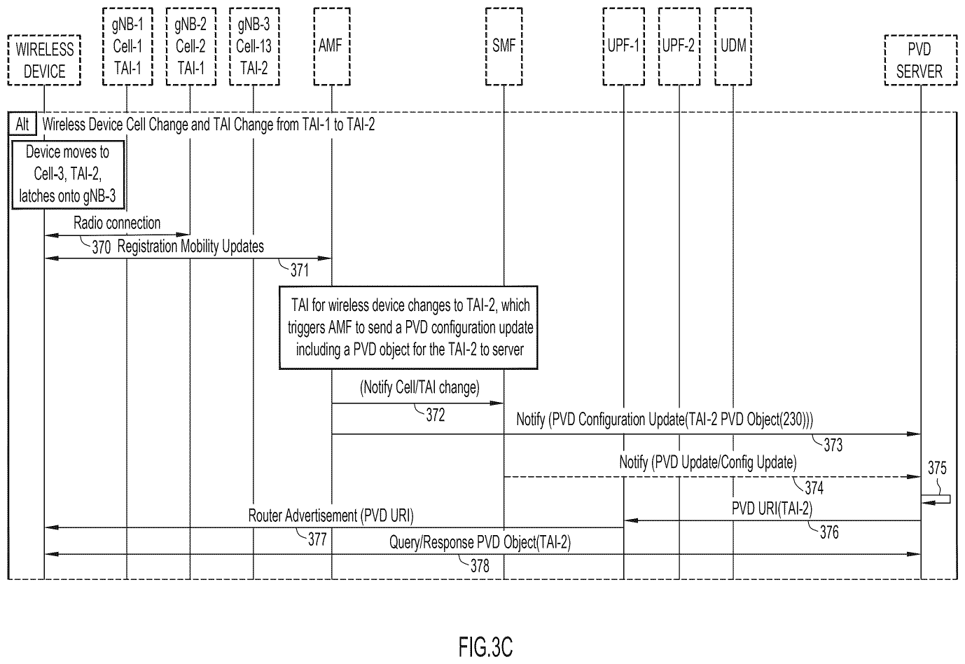

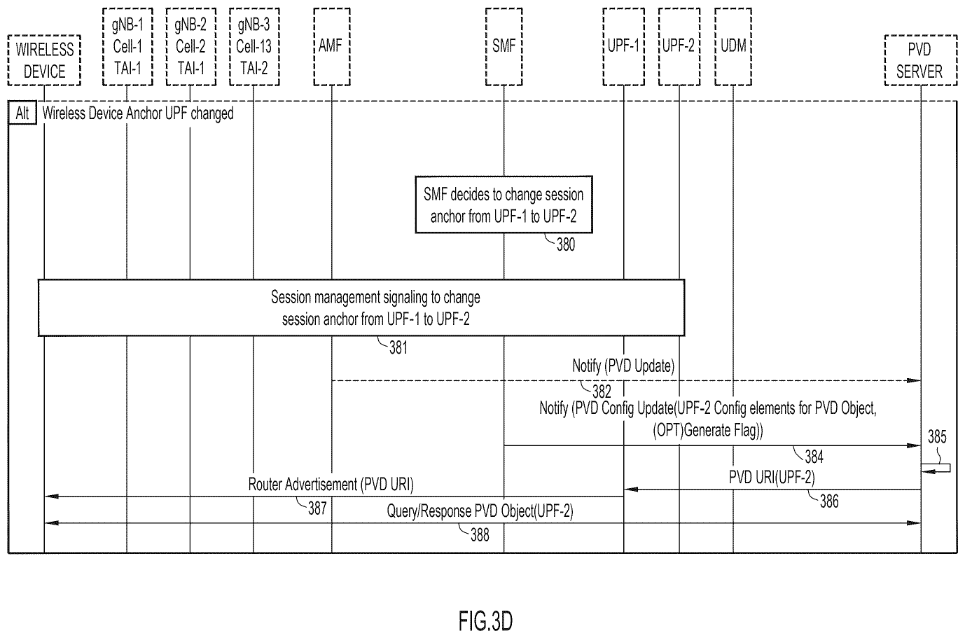

During operation of system 100, when a NF (e.g., any of AMF 112, SMF 114, and/or UDM 118) with which the PVD server 130 has a subscription, detects a triggering event associated with the wireless device 102 (e.g., mobility event, session event, etc.), the NF can send an indication of the triggering event to the PVD server 130. For example, in some instances, the indication of the triggering event may be a PVD update message (also referred to herein as a PVD update) that can include one or more parameters sent to the PVD server 130 in which the one or more parameters are associated with the type of event detected by the NF. Different parameters that may be included in a PVD update message sent to the PVD server 130 are discussed in further detail with reference to TABLE 1 for different example triggering events, below, and also with reference to FIGS. 3A, 3B, 3C, and 3D discussed in further detail below.

In some embodiments, sending an indication of a triggering event can include a NF sending a PVD configuration update message (also referred to herein as a PVD configuration update) to the PVD server 130, for example, to notify the PVD server 130 of new PVD object(s) that are to be generated, stored, and/or updated via the PVD server 130. Any NF of a mobile network can perform PVD configuration updates involving one or more PVD objects in accordance with embodiments herein.

In at least one embodiment, based one or more parameters included in a PVD update message received by the PVD server 130, the PVD server 130 can identify a corresponding PVD object or, in some instances, multiple PVD objects that may be organized in a hierarchical manner, and corresponding PVD URI(s) that can be sent to the wireless device 102 to enable to the wireless device 102 to query/obtain corresponding PVD object(s) for the URI(s).

On querying or accessing a particular PVD URI configured for a particular PVD object, for example, by wireless device 102, the PVD server 130 or some other network element, such as PCF 120, at which the particular PVD object is stored, the network element can provide the particular PVD object to the wireless device 102, potentially formatted in a JSON format, as shown above.

PVD object(s) obtained by the wireless device 102 can influence operations/communications by the wireless device, for example, based on configuration information included in a given PVD object for a particular provisioning domain. In some embodiments, if multiple PVD objects may pertain to a given location/condition of the wireless device 102, the wireless device 102 may also be provided with hierarchical information that influences which PVD object(s) may take precedence over other PVD object(s).

In various embodiments, one or more triggering events that can trigger delivery of a PVD URI and subsequent querying by wireless device 102 may include any combination of:
Initial registration/PDU session establishment by the wireless device 102;
A cell change that impacts PVD information (e.g., disaster roaming information for the wireless device 102, access control for the wireless device 102, etc.);
A TAI change that impacts PVD information (e.g., allowed slice(s) for the wireless device 102, LADN information for the wireless device 102);
Handover of the wireless device 102 (e.g., a connected mode handover);
Subscription configuration change(s) (e.g., a change in subscribed slice(s) for the wireless device 102, etc.);
Roaming into a Visited PLMN (V-PLMN) and/or return to an H-PLMN (from a V-PLMN) by the wireless device 102; and/or.
An anchor UPF is changed for the wireless device 102.

The above list of potential triggering events is not meant to provide an exhaustive list of triggering events that may be used to trigger delivery of a PVD URI and subsequent PVD object querying by wireless device 102 towards PVD server 130. Thus, any other triggering events and/or combinations thereof can be envisioned for delivery of one or more PVD URI(s) and subsequent querying by a wireless device in accordance with embodiments herein.

For example, TABLE 1, below, illustrates different triggering events that may be used to trigger delivery of one or more PVD URI(s) to a wireless device to enable the wireless device to obtain one or more PVD objects. Various triggering events that may be utilized to facilitate delivery of one or more PVD URI(s) to a wireless device may be referred to herein as PVD triggering events, wireless device/UE mobility triggering events, and/or the like.

TABLE 1
PVD EXAMPLE PVD TRIGGERING EVENTS

| | PARAMETERS | TRIGGERING EVENT | SCOPE |
|---|---|---|---|
| | UPF BASED WIRELESS DEVICE CONFIGURATION PARAMETERS | | |
| 1. | Routing Indicator | Wireless device registers to | H-PLMN |
| | | a mobile network | |
| 2. | PEIPS assistance | Wireless device registers to | H-PLMN, V-PLMN |
| | information | a mobile network | |
| 3. | TAI list | Wireless device registration | H-PLMN, V-PLMN, |
| | | or TAI change | or TAI |
| 4. | Service area list | Wireless device registration, | H-PLMN, V-PLMN, |
| | | handover, or TAI change | or TAI |
| 5. | Network identity | Wireless device registration | H-PLMN, V-PLMN |
| | and time zone | or handover | (serving PLMN) |
| | information (Full | | |
| | name for network, | | |
| | short name for | | |
| | network, local time | | |
| | zone, universal time | | |
| | and local time zone, | | |
| | network daylight | | |
| | saving time); Country | | |
| 6. | LADN information; | Wireless device registration | H-PLMN, V-PLMN, |
| | | or TAI change | or TAI |
| 7. | Rejected NSSAI | Wireless device registration | H-PLMN, V-PLMN, |
| | | or TAI change | or TAI |
| 8. | Operator-defined | Cell Change | Cell |
| | access category | | |
| | definitions (e.g., | | |
| | NCGI, etc.) | | |
| 9. | SMS indication | Wireless device registration | H-PLMN, V-PLMN, |
| | | | or TAI |
| 10. | CAG (Closed Access | Cell Change | Cell |
| | Group) information | | |
| | list | | |

With reference to FIGS. 3A, 3B, 3C, and 3D, FIGS. 3A, 3B, 3C, and 3D are a message sequence diagram 300 illustrating various example operations that may be performed to facilitate providing PVD support in a mobile network environment, according to an example embodiment. The mobile network environment of FIGS. 3A, 3B, 3C, and 3D may include a wireless device 302, a gNB-1 304-1 (having a cell ID labeled ‘Cell-1’ and being configured for a first tracking area labeled ‘TAI-1’), a gNB-2 304-3 (having a cell ID labeled ‘Cell-2’ and being configured for TAI-1), a gNB-3 304-3 (having a cell ID labeled ‘Cell-’ and being configured for a second tracking area labeled ‘TAI-2’), an AMF 312, an SMF 314, a UPF-1 316-1, a UPF-2 316-2, a UDM 318, and a PVD server 330.

It is to be understood that the wireless device 302 and NFs of the mobile network environment of FIGS. 3A, 3B, 3C, and 3D may be configured as analogous devices/NFs as discussed above for system 100 of FIG. 1 in accordance with embodiments herein. Reference is made to the PVD objects of FIGS. 2A, 2C, and 2D with regard to various example details/operations/features discussed for FIGS. 3A, 3B, 3C, and 3D in which the PVD object 210 of FIG. 2A and PVD object 240 of 2D may be considered to be configured/stored via PVD server 330, while PVD object 230 of FIG. 2C may be considered to be a TAI-specific PVD object that may be provided to the PVD server 330 based on a mobility event detected for wireless device 302 (discussed with reference to FIG. 3B). Consider further for FIGS. 3A, 3B, 3C, and 3D that the mobile network environment involves a PLMN-ID 410-310, as discussed for the examples above.

As shown at 340, consider that PVD server 330 can be configured with one or more (static) PVD objects (e.g., any PVD objects as discussed for various examples herein), such as PVD object 210 of FIG. 2A (for the Internet provisioning domain and PVD object 240 of FIG. 2D (for the gNB-2 provisioning domain).

Further, it is to be understood that PVD server 330 may obtain or receive one or more PVD objects to be stored at the PVD server 330 and/or update(s) for any PVD object(s) stored at the PVD server 330 from any NFs of the mobile network environment, as discussed in further detail below, via one or more PVD configuration update messages.

Additionally, the PVD server 330 can subscribe to receive notifications, such as PVD updates and/or PVD configuration updates, from one or more NFs regarding various triggering events involving wireless device 302, such as mobility events that may occur for the wireless device (e.g., registration, cell change, TAI change, etc.) that may occur for the wireless device 302, session events (e.g., PDU session establishment, UPF change(s), etc.), and/or subscription event(s) (e.g., registration, subscription-specific PVD object(s) and/or PVD object update(s), etc.) involving wireless device 302.

As shown at 341, the PVD server 330 establishes a subscription with AMF 312 to subscribe for notifications (PVD updates or PVD configuration updates) from the AMF 312 regarding any mobility events updates involving the wireless device 302. As shown at 342, the PVD server 330 establishes a subscription with SMF 314 to subscribe for notifications (PVD updates or PVD configuration updates) from the SMF 314 regarding any session event updates involving the wireless device 302. As shown at 343, the PVD server 330 establishes a subscription with UDM 318 to subscribe for notifications (PVD updates or PVD configuration updates) from UDM 318 regarding any subscription event updates involving wireless device 302.

Various example scenarios involving different PVD object(s) that can be obtained by wireless device 302 are now discussed with regard to different triggering events that can be determined for the wireless device 302.

For example, as shown in FIG. 3A, consider that wireless device 302 is within a WWA coverage area of gNB-1 304-1 (Cell-1, TAI-1) and latches onto gNB-1 304-1, as shown at 344. Thereafter, the wireless device 302 initiates a registration with the mobile network via AMF 312, as shown at 345, which triggers the AMF 312 to perform a registration procedure with UDM 318, as shown at 346, for example to perform authentication for wireless device 302 connection to the mobile network and to obtain subscription information for the wireless device via UDM 318.

In at least one embodiment, as shown at 347, consider that the registration of the wireless device 302 involving the registration procedure performed with the UDM 318 triggers the UDM 318 (based on the subscription established by PVD server 330 with the UDM 318 at 343 to be notified regarding any subscription event updates involving the wireless device 302) to notify the PVD server 330 regarding a PVD configuration update. For example, the UDM 318 may send a PVD object to the PVD server 330 for an IMS provisioning domain for the PLMN-ID 410-310 that includes, at least an IPv4 address and an IPV6 for a P-CSCF, in addition to any other configuration elements/information to be utilized for an IMS session (e.g., as discussed above for FIG. 1). Thus, as shown in FIG. 3A, a PVD configuration update can be used to configure a new, dynamic PVD object for the PVD server 330 based on a triggering event determined for the wireless device 302 (e.g., registration).

Following successful registration with the mobile network, consider, as shown at 348a and 348b, that wireless device 302 seeks to establish a PDU session with the mobile network for the Internet DNN via signaling/communications involving AMF 312 and SMF 314, which triggers SMF 314 to establish an N4 session for the wireless device 302 PDU session with UPF-1 316-1, as shown at 349.

In at least one embodiment, the SMF 314 can include in the N4 establishment procedure signaling to the UPF-1 316-1 a PVD trigger indication that can trigger the UPF-1 316-1 to perform an exchange with PVD server 330, as shown at 350, in order to obtain one or more PVD objects from the PVD server 330, for example, such as the Internet DNN PVD object (e.g., as shown in FIG. 2A) and/or a PVD URI for one or more PVD objects from the PVD server 330. Through such an exchange with the PVD server 330, the UPF-1 316-1 can learn of PVD object(s) that may pertain to the DNN for a PDU session involving the wireless device 302. Thus, in some embodiments, UPF-1 316-1 can be triggered to send a router advertisement (RA) to wireless device 302, as shown at 355, for example, that includes a PVD URI for a given DNN (e.g., the Internet) for which a PDU session is established for the wireless device 302, in order to enable the wireless device 302 to obtain the PVD object pertaining to the DNN from the PVD server 330.

As shown at 351, the SMF 314 can also establish a subscription with AMF 312 to be notified regarding any mobility events (e.g., gNB/cell changes, TAI changes, etc.) involving the wireless device 302.

Other operations can be performed for sending a PVD URI to the wireless device 302, as now discussed with reference to FIG. 3A. For example, as shown at 352, upon determining the PDU session establishment for wireless device 302 for the Internet DNN, the SMF 314 can be triggered (based on the subscription established by PVD server 330 with the SMF 314 at 342 to be notified regarding any session event updates involving the wireless device 302) to send a PVD update to the PVD server 330 that includes one or more parameters, such as the PLMN-ID 410-310 and an indication that the PDU session established for the wireless device 302 is with the Internet DNN.

Obtaining the PVD update indicating a PDU session for the Internet DNN (e.g., an indication of a triggering event for the wireless device 302) causes the PVD server 330 to identify, as generally shown at 353, the PVD object pertaining to the Internet provisioning domain, such as PVD object 210 as discussed for FIG. 2A. Recall, PVD object 210 can be stored in association with or otherwise mapped to the domain to which the object pertains, for example, stored in association with the MCC-MNC and DNN to which the PVD object pertains (e.g., [PVD object 210]<==>410-310 (DNN: Internet)) that can be used to identify the PVD object 210. Upon identifying the PVD object 210, the PVD server 330 parses the PVD object 210 to determine the PVD URI (e.g., “pvd-id”) for the PVD object 210 provides the PVD URI for the PVD object (e.g., pvd://mnc410.mcc310.3gppnetwork.org/DNN/internet) to the UPF-1 316-1, as shown at 354, which triggers the UPF 316-1 to perform the RA towards wireless device 302, as shown at 355, that includes the PVD URI for the PVD object 210.

Upon obtaining the PVD URI, the wireless device 302 performs a URI query/response exchange with PVD server 330, as generally shown at 356, in order to obtain the PVD object 210 from the PVD server 330. Upon obtaining the PVD object 210, the wireless device 302 can perform any DNS queries for the Internet domain with the DNS server as identified in the PVD object 210. Other behavior for the wireless device 302 could also be influenced for the wireless device via other configuration elements that could be configured for the PVD object 210, such as FQDN to use for the DNS server, etc.

Moving to FIG. 3B, consider other example scenarios involving other PVD objects that can be obtained by the wireless device 302 for various triggering events involving the wireless device 302.

For example, as shown at 360, consider that wireless device moves into the coverage area of Cell-2/TAI-1 provided by gNB-2 304-2 and latches onto (performs a handover to) the gNB-2 304-2. The handover to gNB-2 304-2 triggers registration mobility updates with the AMF 312, as shown at 361.

In this scenario, consider that AMF 312 notifies the SMF 314 regarding the cell change, as shown at 362, and also notifies the PVD server 330 (based on the mobility event subscription) via a PVD update regarding the gNB-2 304-2/Cell-2 change involving wireless device 302, as shown at 363. For example, the PVD update sent to the PVD server 330 may include the PLMN-ID 410-310 and the NCI for gNB-2 (e.g., ‘002’, as discussed for FIG. 2D).

In at least one embodiment, as shown at 364, the SMF 314 can also notify the PVD server 330 (based on the session event subscription) if any PDU session changes occur for the wireless device 302.

Obtaining the PVD update including the parameters indicating the gNB-2/Cell-2 change for the wireless device 302 (e.g., an indication of a triggering event for the wireless device 302) causes the PVD server 330, to identify, as generally shown at 365, the PVD object pertaining to the gNB-2 304-2, such as PVD object 240 as discussed for FIG. 2D. Upon identifying the PVD object 240, the PVD server 330 parses the PVD object 240 to determine the PVD URI (e.g., “pvd-id”) for the PVD object 240 and provides the PVD URI for the PVD object (e.g., pvd://mnc410.mcc310.3gppnetwork.org/gNB/002) to the UPF-1 316-1, as shown at 366, which triggers the UPF-1 316-1 to perform the RA towards wireless device 302, as shown at 367, that includes the PVD URI for the PVD object 240.

Upon obtaining the PVD URI, the wireless device 302 performs a URI query/response exchange with PVD server 330, as generally shown at 368, in order to obtain the PVD object 240 from the PVD server 330. Upon obtaining the PVD object 240, the wireless device 302 can perform operations/communications based on the configuration elements of the PVD object 240.

Recall, that any NF can send a PVD configuration update to a PVD server (or any other NF at which one or more PVD objects may be generated/configured/stored/maintained). For example, consider another scenario as shown in FIG. 3C in which the wireless device 302 again moves from the coverage area of Cell-2 provided by gNB-2 304-2 into the coverage area of Cell-3 provided by gNB-3 304-3 and latches onto gNB-3 304-3, as shown at 370.

In this example scenario, the handover to gNB-3 304-3 triggers registration mobility updates with the AMF 312, as shown at 371 and the AMF 312 determines that the TAI for the wireless device 302 is changed from TAI-1 to TAI-2, which triggers the AMF to notify SMF 314 regarding the cell and TAI change, as shown at 372, and to also send to the PVD server 330, as shown at 373, a PVD object for the TAI-2 provisioning domain, such as PVD object 230 as shown in FIG. 2C, via a PVD configuration update message including the PVD object 230.

In at least one embodiment, as shown at 374, the SMF 314 can also notify the PVD server 330 (based on the session event subscription) if any PDU session changes occur for the wireless device 302.

Obtaining the PVD configuration update including the PVD object 230 for the wireless device (e.g., an indication of a triggering event for the wireless device) causes the PVD server 330 to store the PVD object 230 and to parse the PVD object 230 to determine the PVD URI (e.g., “pvd-id”) for the PVD object 230, as generally shown at 375. Upon determining the PVD URI for the PVD object 230 (e.g., pvd://mnc410.mcc310.3gppnetwork.org/TAI/0000000000000002, the PVD server 330 provides the PVD URI to the UPF-1 316-1, as shown at 376, which triggers the UPF 316-1 to perform the RA towards wireless device 302, as shown at 377, that includes the PVD URI for the PVD object 230.

Upon obtaining the PVD URI, the wireless device 302 performs a URI query/response exchange with PVD server 330, as generally shown at 378, in order to obtain the PVD object 230 from the PVD server 330. Upon obtaining the PVD object 230, the wireless device 302 can perform operations/communications based on the configuration elements of the PVD object 230. For example, the wireless device 302 can use the PVD object to identify the IP address of the ePDG (2.2.2.2, in this example) server to be utilized for trusted non-3GPP WLAN communications while within TAI-2.

In some embodiments a PVD configuration update sent to a PVD server (or PCF) can be used to trigger the PVD server to generate and store a PVD object for a particular provisioning domain based on various parameters, such as PVD configuration elements, which can be included in the PVD configuration update. In some embodiments, such a PVD configuration update can include a generate indication (e.g., a flag, a bit, a byte, a control word, an information element (IE), etc.) that can be used to instruct the PVD server that it is to generate a particular PVD object, for example, based on a predefined JSON PVD object format configured for the PVD server and a predictable PVD URI format configured therefor, for a particular provisioning domain based on parameter(s) contained in the PVD configuration update. Other variations for triggering generation/storage of a given PVD object by a PVD server (or PCF) can be envisioned.

With reference to FIG. 3D, consider that SMF 314 determines to move the PDU session for wireless device 302 from UPF-1 316-1 to UPF-2 316-2, as shown at 380, and performs various signaling (per-3GPP standards) among the wireless device 302, the AMF 312, UPF-1 316-1 UPF-2 316-2 to facilitate the move, as generally shown at 381.

In at least one embodiment, as shown at 382, the AMF 312 can notify the PVD server 330 (based on the mobility event subscription) if any mobility changes occur for the wireless device 302 due to the session movement.

As shown at 384, the SMF 314 can send a PVD configuration update to the PVD server 330 that includes one or more configuration elements that the PVD server 330 is to utilize to generate a PVD object for the UPF-2 provisioning domain. In some embodiments, the PVD configuration update can include a generate indication that is to trigger the PVD server 330 to generate the PVD object.

In one example, consider that a PVD object (with a predictable PVD URI for the UPF-2 316-2 provisioning domain) is generated by the PVD server 330, as generally shown at 385, as follows:

| | |
|---|---|
| { | |
| | “pvd-id”: “pvd://mnc410.mcc310.3gppnetwork.org/UPF/3161”, |
| | “service”: “UPF”, |
| | “description”: “UPF level configuration information”, |
| | “DNS FQDN”: “outbound2-dns.example2.com”, |
| | “DNS ” : “2001:ac3::2” |
| } | |

Upon generating and storing the PVD object, the PVD server 330 provides the PVD URI for the generated PVD object (e.g., pvd://mnc410.mcc310.3gppnetwork.org/UPF/3162) to the UPF-2 316-2, as shown at 386, which triggers the UPF-2 316-2 to perform the RA towards wireless device 302, as shown at 387, that includes the PVD URI for the newly generated PVD object.

Upon obtaining the PVD URI, the wireless device 302 performs a URI query/response exchange with PVD server 330, as generally shown at 388, in order to obtain the newly generated PVD object for the UPF-2 provisioning domain from the PVD server 330. Upon obtaining the PVD object, the wireless device 302 can perform operations/communications based on the configuration elements of the PVD object.

Accordingly, embodiments herein may facilitate provisioning domain support for a mobile network environment. The structure of PVD objects discussed herein provides for the ability to organize PVD configurations in a structured manner and allows the network to compartmentalize configurations as PVD domains. PVDs can be defined at slice levels, DNN levels, cell levels, NF levels, etc. a key outcome of this approach is the realization of an access agnostic configuration interface between wireless devices and a mobile network. In some instances, embodiments herein may allow a mobile network to deliver such provisioning domain information to a wireless device via a URSP and/or any other configurations as PVD objects/configurations.

Although examples discussed for FIGS. 3A, 3B, 3C, and 3D are discussed with reference to providing a PVD URI to a wireless device, in some embodiments, a wireless device can be triggered to generate a corresponding PVD URI since PVD URIs as discussed for embodiments herein may comply with a unique, but predictable format for a given service domain/PLMN. For example, by providing service level information to a wireless device for a given domain (e.g., TAI=0000000000000000001) by a PVD server, by communicating service level information and a flag/control word to trigger PVD URI generation by a wireless device, by indicating to a wireless device that it is to obtain a PVD object based on its current location/TAI/RAI/etc., combinations thereof, and/or the like, a given wireless device can be triggered to generate a PVD URI corresponding to a given PVD object corresponding to a service level/domain (e.g., for a given PLMN) in order to obtain the PVD object from a corresponding network resource.

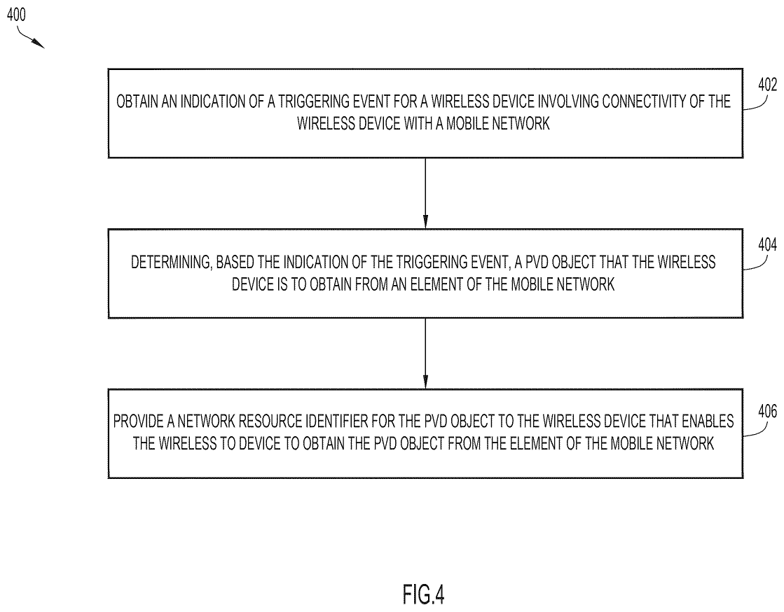

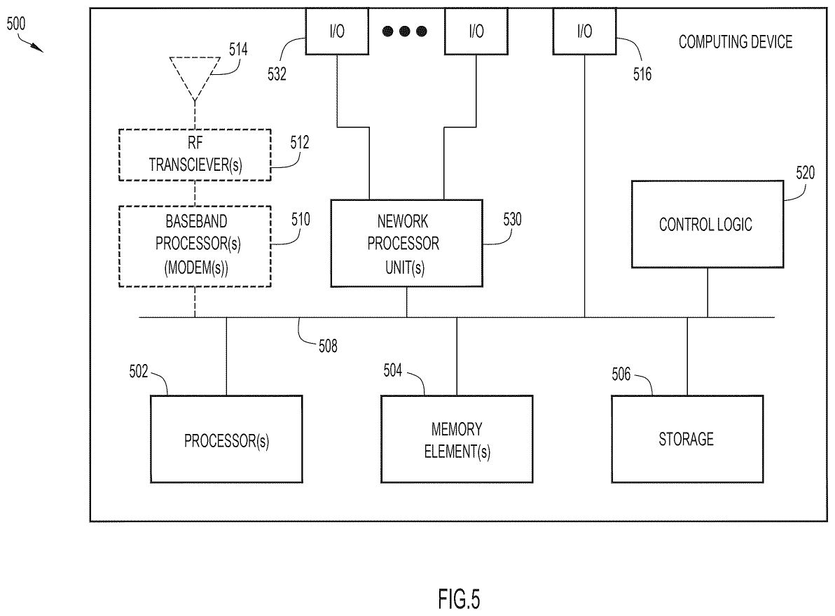

Referring to FIG. 4, FIG. 4 is a flow chart depicting a method 400 according to an example embodiment. In at least one embodiment, method 400 illustrates operations that may be performed by one or more network nodes, such as any combination of an AMF, an SMF, a UPF, and/or a PVD server (potentially implemented via a PCF) as discussed for embodiments herein.

At 402, the method may include obtaining an indication of a triggering event for a wireless device involving connectivity of the wireless device with a mobile network. In various embodiments, the indication of the triggering event may be a PVD update including one or more parameters, a PVD configuration update including a PVD object, or a PVD configuration update including one or more parameters that are to be used to generate a PVD object. The indication can be obtained based on a subscription established by a network element (e.g., a PVD server, a PCF, etc.) to be notified regarding one or more triggering events (e.g., mobility events, session events, and/or subscription events) involving a wireless device.

At 404, the method may include determining, based the indication of the triggering event, a PVD object that the wireless device is to obtain from an element of the mobile network. In at least one embodiment, the determining can include identifying the PVD object stored at the element based on one or more parameters included in the indication (e.g., via a PVD update). In at least one embodiment the determining can include identifying the PVD object included in the indication (e.g., via PVD configuration update). In at least one embodiment, the determining can include generating and storing the PVD object based on one or more parameters (e.g., configuration elements) included in the indication (e.g., via a PVD configuration update, potentially including a generate indication indicating that the element is to generate the PVD object).

At 406, the method may include providing a network resource identifier for the PVD object to the wireless device that enables the wireless to device to obtain the PVD object from the element of the mobile network. In at least one embodiment, the network resource identifier is a Uniform Resource Identifier (URI) associated with the particular PVD object that enables the wireless device to obtain the particular PVD object from the element (e.g., a PVD server, a PCF, etc.) of the mobile network. Although URIs are discussed for various examples herein, it is to be understood that Uniform Resource Locators (URLs) any/or any other identifiers that may identify a network, cloud, etc. location, resource, etc. from which a wireless device may obtain one or more PVD objects can be envisioned in accordance with embodiments herein.

Referring to FIG. 5, FIG. 5 illustrates a hardware block diagram of a computing device 500 that may perform functions associated with operations discussed herein in connection with the techniques described for embodiments herein. In various embodiments, a computing device or apparatus, such as computing device 500 or any combination of computing devices 500, may be configured as any entity/entities in order to perform operations of the various techniques discussed for embodiments herein, such as any elements, functions, etc. discussed for embodiments herein (e.g., wireless device 102/302, AMF 112/312, SMF 114/314, UPF 116/316-1/316-2, UDM 118/318, PCF 120, PVD server 130/330, etc.).

In at least one embodiment, the computing device 500 may be any apparatus that may include one or more processor(s) 502, one or more memory element(s) 504, storage 506, a bus 508, one or more network processor unit(s) 530 interconnected with one or more network input/output (I/O) interface(s) 532, one or more I/O interface(s) 516, and control logic 520. In various embodiments, instructions associated with logic for computing device 500 can overlap in any manner and are not limited to the specific allocation of instructions and/or operations described herein.

For embodiments in which computing device 500 may be implemented as any device capable of wireless communications, such as wireless wide area network and/or wireless local area network communications, computing device 500 may further include at least one baseband processor or modem 510, one or more radio RF transceiver(s) 512 (e.g., any combination of RF receiver(s) and RF transmitter(s)), one or more antenna(s) or antenna array(s) 514.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 530 may enable communication between computing device 500 and other systems, entities, etc., via network I/O interface(s) 532 (wired and/or wireless) to facilitate operations discussed for various embodiments described herein. In various embodiments, network processor unit(s) 530 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 532 can be configured as one or more Ethernet port(s), Fibre Channel ports, any other I/O port(s), and/or antenna(s)/antenna array(s) now known or hereafter developed. Thus, the network processor unit(s) 530 and/or network I/O interface(s) 532 may include suitable interfaces for receiving, transmitting, and/or otherwise communicating data and/or information (wired and/or wirelessly) in a network environment.

I/O interface(s) 516 allow for input and output of data and/or information with other entities that may be connected to computing device 500. For example, I/O interface(s) 516 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 500 is implemented as a wireless device or any apparatus capable of wireless communications, the RF transceiver(s) 512 may perform RF transmission and RF reception of wireless signals via antenna(s)/antenna array(s) 514, and the baseband processor or modem 510 performs baseband modulation and demodulation, etc. associated with such signals to enable wireless communications for computing device 500.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may facilitate providing PVD support in a mobile network environment. In one form, a computer implemented method is provided that may include obtaining an indication of a triggering event for a wireless device involving connectivity of the wireless device with a mobile network; determining, based the indication of the triggering event, a provisioning domain (PVD) object that the wireless device is to obtain from an element of the mobile network; and providing a network resource identifier for the PVD object to the wireless device that enables the wireless to device to obtain the PVD object from the element of the mobile network.

In at least one instance, the network resource identifier is a Uniform Resource Identifier (URI) that enables to the wireless device to query the element of the mobile network and obtain the PVD object.

In various instances, the triggering event is at least one of: a mobility event involving the wireless device; a session event involving the wireless device; or a subscription event involving the wireless device.

In at least one instance, the computer-implemented method may further include establishing a subscription with a network function by a server at which the PVD object is stored or is capable of being stored or that is capable of generating and storing the PVD object, wherein the subscription is to cause the network function to notify the server regarding one or more triggering events involving the wireless device. In at least one instance, the obtaining is based on the subscription with the network function.

In at least one instance, obtaining the indication of the triggering event includes obtaining one or more parameters associated with the triggering event (e.g., obtained via a PVD update message) and determining the PVD object includes the server identifying the PVD object being stored at the server based on the one or more parameters.

In at least one instance, obtaining the indication of the triggering event includes obtaining the PVD object (e.g., obtained via a PVD configuration update message) and determining the PVD object includes the server storing the PVD object.

In at least one instance, obtaining the indication of the triggering event includes obtaining one or more parameters associated with the triggering event and the determining includes generating and storing the PVD object by the server based on the one or more parameters (e.g., obtained via a PVD configuration update message that triggers the server to generate and store the PVD object).

In at least one instance, the computer-implemented method is performed by a provisioning domain server. In at least one instance, the computer-implemented method is performed by a policy control function (PCF).

### Variations and Implementations

Generally, per-3GPP standards for a mobile network, also typically referred to as a mobile core network, an AMF interfaces with a SMF which can further interface with one or more UPFs. An AMF and an SMF can further interface with PCF, a UDM/UDR, and various other core network functions via 3GPP Service-Based Interface (SBI) constructs/interfaces and/or any other 3GPP interfaces/reference points. An AMF and a UPF can further interface with a RAN node, such as one or more gNBs or disaggregated components thereof.

One or more wireless device sessions, often referred to as PDU sessions can be established between a wireless device and a UPF for a core network in which the session may be facilitated/managed by an SMF, as is generally understood in the art.

Generally, a radio access may include one or more radio access network (RAN) radio nodes that may implement a wireless wide area (WWA) (e.g., cellular) air interface and, in some instances also a wireless local area (WLA) (e.g., Wi-Fi®) air interface, for any combination of Radio Access Technology (RAT) types (e.g., ‘accesses’), such as 3GPP WWA licensed spectrum accesses (e.g., Fourth Generation/Long Term Evolution (4G/LTE), 5G/New Radio (NR) accesses); 3GPP unlicensed spectrum accesses (e.g., Licensed-Assisted Access (LAA), enhanced LAA (eLAA), further enhanced LAA (feLAA), and New Radio Unlicensed (NR-U)); non-3GPP licensed/unlicensed spectrum wireless local area (WLA) accesses such as Institute of Electrical and Electronics Engineers (IEEE) 802.11 (e.g., Wi-Fi®); IEEE 802.16 (e.g., WiMAX®), Near Field Communications (NFC), Bluetooth®, and/or the like; Citizens Broadband Radio Service (CBRS) accesses; combinations thereof; and/or the like.

Thus, a WWA radio node may be inclusive of any configuration/combination of 3GPP 4G/LTE evolved Node Bs (eNBs or eNodeBs), 5G next Generation Node Bs (gNBs or gNodeBs), and/or any other next Generation access nodes that may include hardware and/or software to perform baseband signal processing (such as modulation/demodulation) as well as hardware (e.g., baseband processors (modems), transmitters and receivers, transceivers, and/or the like)), software, logic and/or the like to facilitate signal transmissions and signal receptions via antenna assemblies (not shown) in order to provide over-the-air Radio Frequency (RF) coverage for one or more access types (e.g., 4G/LTE, 5G, nG, CBRS, etc.) through which one or more wireless devices (e.g., wireless device 102), may utilize to connect for one or more sessions (e.g., voice/IMS, data/internet (e.g., video, gaming, etc.), combinations thereof, etc.). A WLA radio node may be inclusive of any configuration/combination on non-3GPP access nodes or access points (APs) that may include hardware and/or software to perform baseband signal processing (such as modulation/demodulation) as well as hardware (e.g., baseband processors (modems), transmitters and receivers, transceivers, and/or the like)), software, logic and/or the like to facilitate signal transmissions and signal receptions via antenna assemblies (not shown) in order to provide over-the-air Radio Frequency (RF) coverage for one or more WLA access types/protocols (e.g., Wi-Fi 5, Wi-Fi6/6E, Wi-Fi7, Wi-Fi8, etc.), may utilize to connect for one or more sessions

A UE or wireless device, such as wireless device 102, or any other wireless devices discussed herein, may be considered any electronic device, etc. that initiates a connection or communication session with a corresponding core network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a router or gateway with a WWA interface, a WWA/WLA (cellular/Wi-Fi®) enabled device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more RAN(s).

Generally, an AMF may facilitate access and mobility management control/services for one or more wireless devices seeking connection to/connected to a mobile network. Generally, an SMF may be responsible for wireless device session management, with individual functions/services being supported on a per-session basis in order to facilitate data transfer(s) between a wireless device and one or more networks via one or more UPFs. Generally, a UPF may operate to provide packet routing and forwarding operations for user data traffic and may also perform a variety of functions such as packet inspection, traffic optimization, Quality of Service (QoS), policy enforcement and user data traffic handling (e.g., to/from one or more data networks), billing operations (e.g., accounting, etc.), among other operations, for wireless device sessions. Typically, a UDM stores subscription data (typically in combination with a UDR) for subscribers (e.g., a user that may be associated with a given wireless device) that can be retrieved and/or otherwise obtained/utilized during operation of a core network system. Typically, a PCF stores policy data in order to provide policy control services (e.g., to facilitate access control for one or more UEs, such as wireless device 102, network selection, etc.). Typically, a charging function (CHF) provides support for charging services such as facilitating the transfer of policy counter information associated with subscriber (e.g., UE) spending limits, etc.

In general, authentication services may include authenticating and/or authorizing one or more device(s) for one or more connections and/or communications and may be inclusive of any Authentication, Authorization, and Accounting (AAA) services that may be facilitated via any combination of authentication/authorization protocols such as Remote Authentication Dial-In User Service (RADIUS), DIAMETER, Extensible Authentication Protocol (EAP) [including any EAP variations], and/or the like. Generally, authentication refers to a process in which an entity's identity is authenticated, typically by providing evidence that it holds a specific digital identity such as an identifier/identity and corresponding credentials/authentication attributes/etc. Generally, authorization can be used to determine whether a particular entity is authorized to perform a given activity.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining an indication of a triggering event for a wireless device involving connectivity of the wireless device with a mobile network;
determining, based the indication of the triggering event, a provisioning domain (PVD) object that the wireless device is to obtain from an element of the mobile network; and
providing a network resource identifier for the PVD object to the wireless device that enables the wireless to device to obtain the PVD object from the element of the mobile network.

2. The method of claim 1, wherein the network resource identifier is a Uniform Resource Identifier (URI) that enables to the wireless device to query the element of the mobile network and obtain the PVD object.

3. The method of claim 1, wherein the triggering event is at least one of:
a mobility event involving the wireless device;
a session event involving the wireless device; or
a subscription event involving the wireless device.

4. The method of claim 1, further comprising:
establishing a subscription with a network function by a server at which the PVD object is stored or is capable of being stored or that is capable of generating and storing the PVD object, wherein the subscription is to cause the network function to notify the server regarding one or more triggering events involving the wireless device.

5. The method of claim 4, wherein the obtaining is based on the subscription with the network function.

6. The method of claim 4, wherein obtaining the indication of the triggering event includes obtaining one or more parameters associated with the triggering event and determining the PVD object includes the server identifying the PVD object being stored at the server based on the one or more parameters.

7. The method of claim 4, wherein obtaining the indication of the triggering event includes obtaining the PVD object and determining the PVD object includes the server storing the PVD object.

8. The method of claim 4, wherein obtaining the indication of the triggering event is one or more parameters associated with the triggering event and the determining includes generating and storing the PVD object by the server based on the one or more parameters.

9. The method of claim 1, wherein the method is performed by a provisioning domain server.

10. The method of claim 1, wherein the method is performed by a policy control function (PCF).

11. One or more non-transitory computer readable storage media encoded with instructions that, when executed by a processor, cause the processor to perform operations, comprising:
obtaining an indication of a triggering event for a wireless device involving connectivity of the wireless device with a mobile network;
determining, based the indication of the triggering event, a provisioning domain (PVD) object that the wireless device is to obtain from an element of the mobile network; and
providing a network resource identifier for the PVD object to the wireless device that enables the wireless to device to obtain the PVD object from the element of the mobile network.

12. The media of claim 11, wherein the network resource identifier is a Uniform Resource Identifier (URI) that enables to the wireless device to query the element of the mobile network and obtain the PVD object.

13. The media of claim 11, wherein the instructions, when executed by the processor, cause the processor to perform further operations, comprising:
establishing a subscription with a network function by a server at which the PVD object is stored or is capable of being stored or that is capable of generating and storing the PVD object, wherein the subscription is to cause the network function to notify the server regarding one or more triggering events involving the wireless device, wherein the obtaining is based on the subscription with the network function.

14. The media of claim 13, wherein obtaining the indication of the triggering event includes obtaining one or more parameters associated with the triggering event and determining the PVD object includes the server identifying the PVD object being stored at the server based on the one or more parameters.

15. An apparatus, comprising:
at least one memory element for storing data; and
at least one processor for executing instructions associated with the data, wherein executing the instructions causes the apparatus to perform operations, comprising:
obtaining an indication of a triggering event for a wireless device involving connectivity of the wireless device with a mobile network;
determining, based the indication of the triggering event, a provisioning domain (PVD) object that the wireless device is to obtain from an element of the mobile network; and
providing a network resource identifier for the PVD object to the wireless device that enables the wireless to device to obtain the PVD object from the element of the mobile network.

16. The apparatus of claim 15, wherein the network resource identifier is a Uniform Resource Identifier (URI) that enables to the wireless device to query the element of the mobile network and obtain the PVD object.

17. The apparatus of claim 15, wherein executing the instructions causes the apparatus to perform further operations, comprising:
establishing a subscription with a network function by a server at which the PVD object is stored or is capable of being stored or that is capable of generating and storing the PVD object, wherein the subscription is to cause the network function to notify the server regarding one or more triggering events involving the wireless device, wherein the obtaining is based on the subscription with the network function.

18. The apparatus of claim 17, wherein obtaining the indication of the triggering event includes obtaining one or more parameters associated with the triggering event and determining the PVD object includes the server identifying the PVD object being stored at the server based on the one or more parameters.

19. The apparatus of claim 17, wherein obtaining the indication of the triggering event includes obtaining the PVD object and determining the PVD object includes the server storing the PVD object.

20. The apparatus of claim 17, wherein obtaining the indication of the triggering event is one or more parameters associated with the triggering event and the determining includes generating and storing the PVD object by the server based on the one or more parameters.
